(19) United States
(12) Patent Application Publication
(10) Pub. No.: US 2007/0028537 A1
(43) Pub. Date: Feb. 8, 2007

(54) Doorframe structure

(76) Inventor: Hsun-Chuan Chuang, Jhoughe City (TW)

Correspondence Address: Troxell Law Office Pllc, Suite 1404, 5205 Leesburg Pike, Falls Church, VA, 22041, US

(21) Appl. No.: 11/195,834

(22) Filed: Aug. 3, 2005

(51) Int. Cl. E06B 1/04

(52) U.S. Cl. 52/204.1

(57) ABSTRACT

A doorframe structure is composed of a doorframe, spring locks, and decorative panels fastened to the doorframe. The doorframe is provided with pluralities of fish-eye holes and grooves. By way of piercing screws through the fish-eye hoes, the doorframe is fastened to the pre-constructed holes on the wall. Each of the spring locks includes a base and an insertion locking device, which are installed inside the groove and on the backside of the decorative panel, respectively. By way of the spring locks, the decorative panels can be fastened to the doorframe to accomplish a novel doorframe structure. Accordingly, the doorframe structure can be installed after the wall has been completed constructed, thus avoiding the inconvenience occurred in construction of the doorframe of the prior art, i.e., the doorframe must be installed before completing the construction of the wall.

### BACKGROUND OF THE INVENTION

(a) Field of the invention

The present invention relates to a doorframe structure, particularly to a doorframe that can be installed after completing the construction of the wall.

(b) Description of the Prior Art

In constructing a doorframe of the prior art, the doorframe must be installed before the partition wall has been completed. As shown in FIG. 5, a doorframe 10a is connected via supporters 11a, such that the doorframe 10a can be in a rectangular form. Besides, while long nails 12a are pre-provided to pierce out of the doorframe 10a, the bricklayer would have the bricks and cement hold the long nails 12a at the time of building the wall, thereby the doorframe 10a would be fastened to the pre-determined position of the wall 20a (or the concrete structure). Thereafter, bricks or concrete is filled up the crevice between the doorframe and the wall. Subsequently, the wall is polished and painted, and finally the surface of the doorframe is embellished and painted. Taiwan Patent No. 88110456 entitled “construction of the main doorframe and assembly of its secondary doorframe” is one of the references in this respect.

However, the following disadvantages do exist in the doorframe construction of the prior art:

1. The doorframe of the prior art must be installed during the construction of the wall, and the bricklayer and the doorframe installer must wait for and cooperate with each other, thus unable to work independently, rendering a waste of time and cost.

2. Construction of the doorframe of the prior art requires supporters for connection purposes, and long nails for fastening to the wall. As the doorframe is generally made of wood material, it is easily transformed due to the humidity in the air. As the long nails can fasten the doorframe vertically, rather than horizontally, they will easily detach from the doorframe made of wood material when the doorframe is bulged and transformed. Furthermore, in case the doorframe is transformed seriously and the door is hard to close, repair and planning needed would be time-and-cost consuming.

3. As the doorframe of the prior art must be installed during the construction of the wall, it is easily damaged due to the crash by the other working staff during moving the doorframe. Additional repair and maintenance are cost-wastihg.

4. After the completion of the interior partition work, the doorframe of the prior art cannot be shifted to other position, rendering inconveniences in interior design and upholstery.

Concluded above, it is obvious that inconveniences and disadvantages do exist in installation of the doorframe of the prior art, and there is a need in improvement of the structure thereof.

In view of the above, the inventor has the motive to research, design and prepare the present invention, in an attempt to efficiently improve the disadvantages existent in the prior art.

### SUMMARY OF THE INVENTION

The primary object of the invention is to provide an improved structure of a doorframe, which can be installed after completing the construction of the wall, thereby efficiently solving the inconvenience and disadvantages existent in the construction of the doorframe of the prior art.

Another object of the invention is to provide an improved structure of a doorframe, which can allow the doorframe made by molds, thus allowing interior upholstery more efficient and partition work more convenient.

To obtain the above objects, the improved structure of the doorframe according to the invention is provided with a doorframe, spring locks, and decorative panels fastened to the doorframe. The doorframe is provided with pluralities of fish-eye holes and grooves. By way of piercing screws through the fish-eye hoes, the doorframe is fastened to the pre-constructed holes on the wall. Each of the spring locks includes a base and an insertion locking device, which are installed inside the groove and on the backside of the decorative panel, respectively. By way of the spring locks, the decorative panels can be fastened to the doorframe to accomplish a novel doorframe structure.

To completely appreciate these and other objects of the present invention as well as the invention itself, all of which will become apparent to those skilled in the art, the following detailed description of the invention and the claims should be read in conjunction with the accompanying drawings.

### BRIEF DESCRIPTION OF THE DRAWINGS

FIG. 1 is an exploded view of the present invention.

FIG. 2 is a perspective view of the present invention after being assembled.

FIG. 3 is an exploded view being partially enlarged.

FIG. 4 is a cut-away view taken from FIG. 3, showing assembly of the insertion lock.

FIG. 5 is a perspective view of the doorframe according to the prior art.

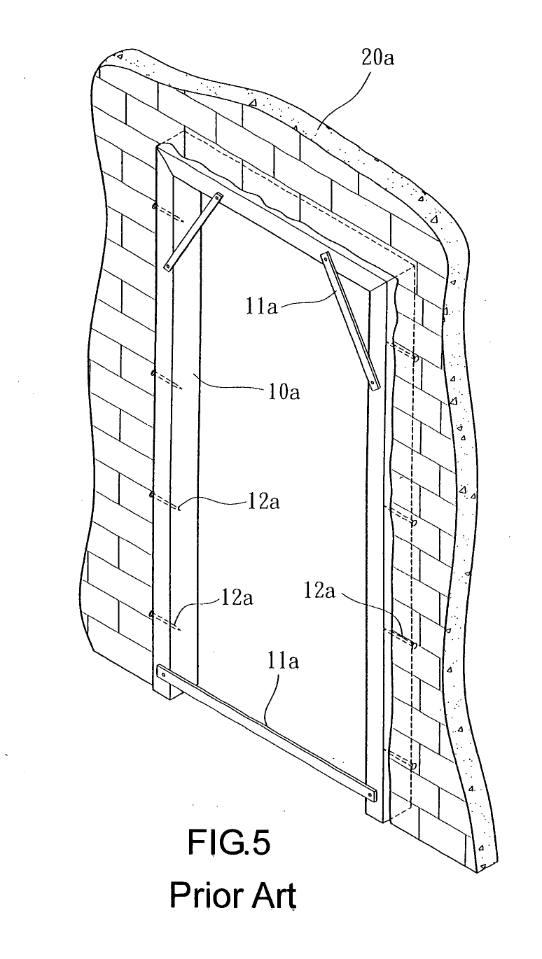

### DETAILED DESCRIPTION OF THE PREFERRED EMBODIMENTS

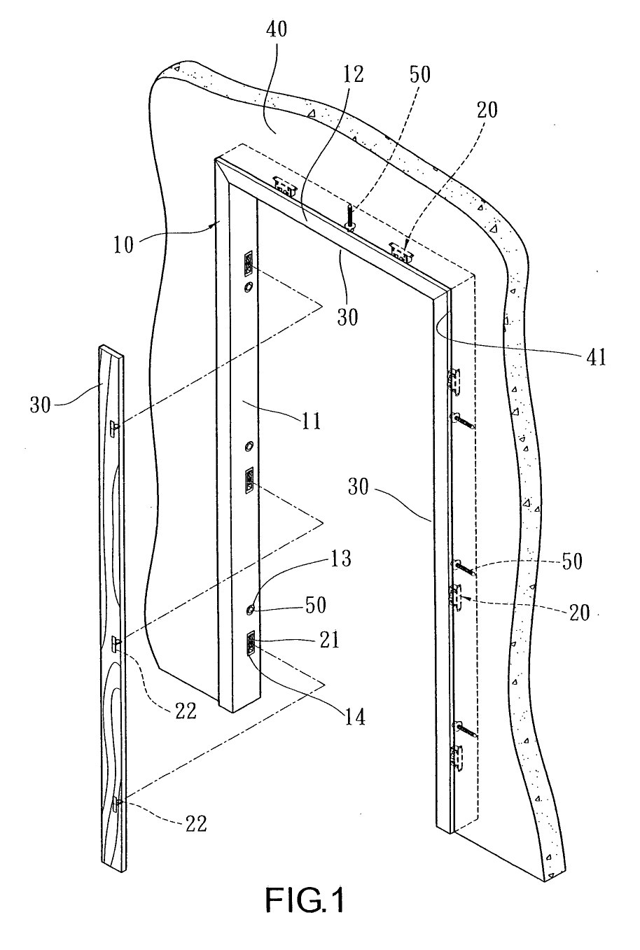

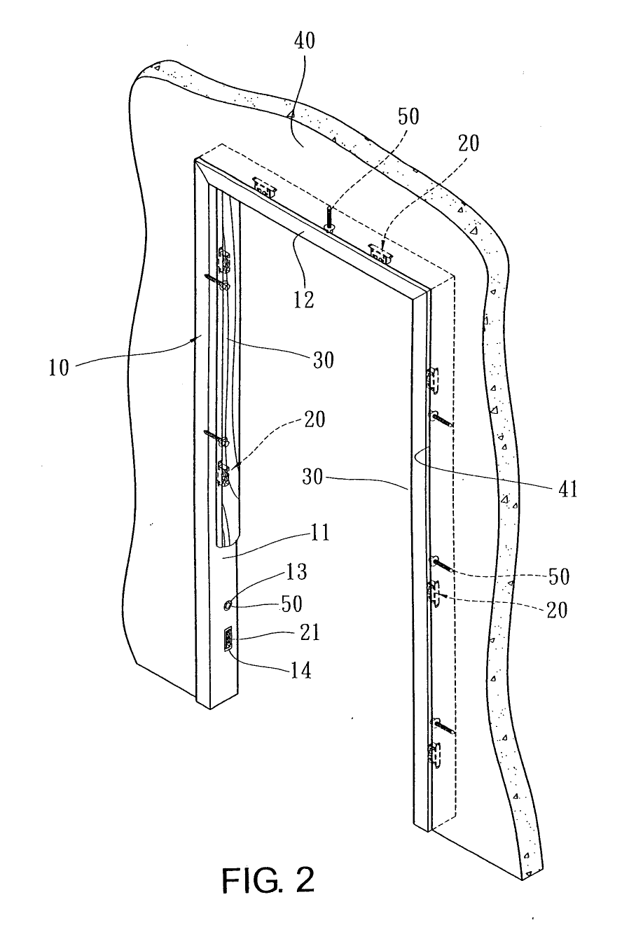

As shown in FIGS. 1 to 3, the invention relates to an improved structure of a doorframe, which is composed of a doorframe 10, spring locks 20, and decorative panels 30 fastened to the doorframe 10.

The doorframe 10 is composed of a pair of vertical jambs 11 and a cornice 12, all of which are provided with pluralities of fish-eye holes 13 and grooves 14 in a certain or uncertain distance.

Each of the spring locks 20 includes a base 21 and an insertion locking device 22. The base 21 is installed inside the groove via screws 23, while the insertion locking device 22 is fastened to the backside of the decorative panel 30, such that the insertion locking device 22 can be correspondingly inter-locked with the base 21.

The decorative panels 30 are prepared in coordination with the doorframe 10 on which the fish-eye holes 13 and grooves 14 are provided. By way of fastening the insertion locking devices 22 provided on the backside of the decorative panels 30 to the base 21 on the doorframe 10, the decorative panels 30 can be firmly held on the doorframe 10. The surface of the decorative panels 30 can be adhered with specific veneers such as mahogany, whitewood, walnut, teakwood, cherry wood, maple, rosewood and juniper which all have thin laminae.

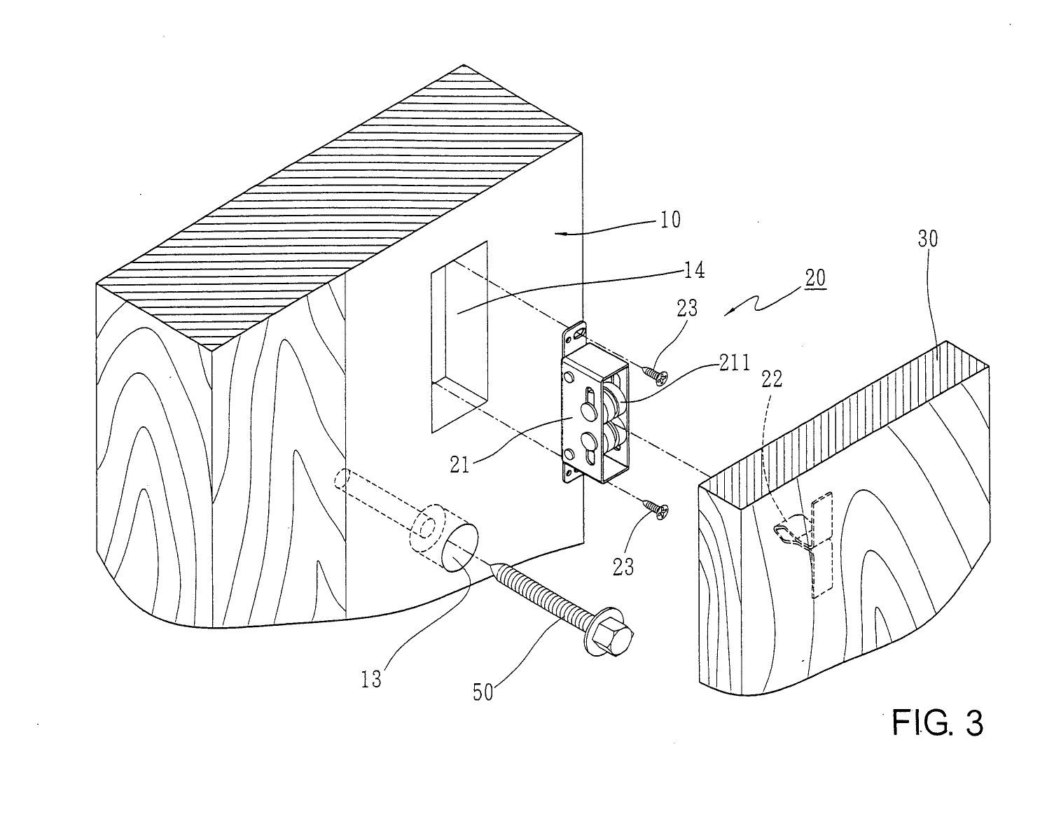

In installation of the doorframe, the doorframe 10 can be directly combined to the pre-provided holes 41 of the wall 40 after the wall 40 is completely constructed. Subsequently, screws 50 are pierced through the fish-eye holes 13 on the doorframe 10 to the corresponding holes pre-drilled on the wall 40 by a driller (not shown), thereby the vertical jambs 11 and cornice 12 of the doorframe 10 can be fastened to the wall 40. Furthermore, the bases 21 of the spring locks 20 are fastened to the grooves 14 of the doorframe 10 via screws 23, while the insertion locking devices 22 are pre-held on the backside of the decorative panels 30. After the doorframe 10 is firmly fastened to the wall 40, the extrusions 221 at the front end of the insertion locking device 22 can be instantly inserted between the two rollers 211 (as shown in FIG. 3) provided inside the base of the decorative panels 30. Accordingly, the decorative panels 30 can be locked and fastened to the doorframe 10.

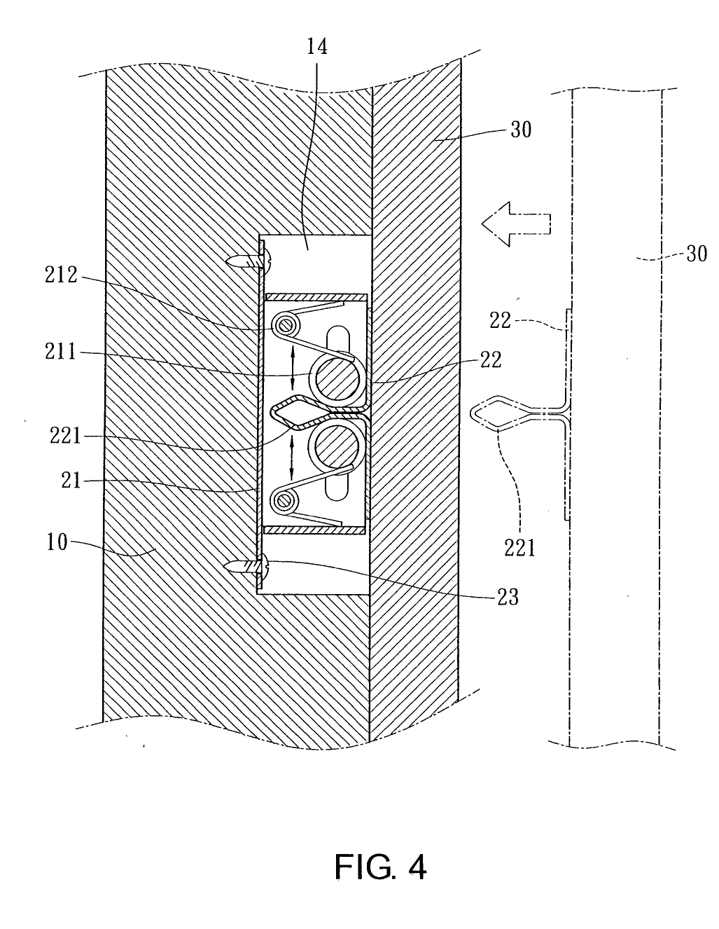

As shown in FIGS. 3 and 4, the base 21 of the spring lock 20 is interiorly provided with a pair of rollers 211 which form a locking clamp via the pressure of the springs 212. Besides, outwardly expanding extrusions 221 are provided at the two sides of the insertion locking devices 22. When the base 21 and the insertion locking device 22 are inter-locked, the rollers 211 in the base 21 would roll and inter-lock with the extrusions 221 of the insertion locking devices 22, forming an appropriate tensile strength for inter-locking. Accordingly, the decorative panels 30 can be locked and fastened to the doorframe 10.

Concluded above, the certain novel features of this invention have been shown and described and are pointed out in the annexed Claims. While the doorframe can be installed after the wall is completely constructed, the inconveniences and disadvantages occurred in the construction of the prior can be efficiently solved.

Although specific embodiments have been illustrated and described, it will be obvious to those skilled in the art that various modifications may be made without departing from what is intended to be limited solely by the appended claims.

1. A doorframe structure comprising a doorframe, spring locks, and decorative panels fastened to the doorframe, characterized in that: the doorframe is composed of a pair of vertical jambs and a cornice, all of which are provided with pluralities of fish-eye holes and grooves; each of the spring locks includes a base installed inside the groove, and an insertion locking device fastened to the backside of the decorative panel; and the decorative panels are provided with insertion locking devices for fastening to the bases inside the grooves of the doorframe.

2. The doorframe structure according to claim 1, wherein screws are pierced into the fish-eye holes in the doorframe for fastening the doorframe to the wall.

3. The doorframe structure according to claim 1, wherein the bases are fastened to the grooves of the doorframe via screws.

4. The doorframe structure according to claim 1, wherein the surface of the decorative panels can be adhered with specific veneers such as mahogany, whitewood, walnut, teakwood, cherry wood, maple, rosewood and juniper which all have thin laminae.
